(19) United States
(12) Patent Application Publication
(10) Pub. No.: US 2018/0245923 A1
(43) Pub. Date: Aug. 30, 2018

(54) ELECTRONIC MACHINE EQUIPMENT

(71) Applicant: BOE Technology Group Co., Ltd., Beijing (CN)

(72) Inventor: Yang HAN, Beijing (CN)

(21) Appl. No.: 15/561,770

(22) PCT Filed: Mar. 16, 2017
(86) PCT No.: PCT/CN2017/076922

§ 371 Date: Sep. 26, 2017

(30) Foreign Application Priority Data
Aug. 10, 2016 (CN) 201610652816.1

(51) Int. Cl. G01C 21/10; G05D 1/00; G01C 21/20; H04W 4/024; G06F 3/01

(52) U.S. Cl. CPC G01C 21/10; G05D 1/00; G06T 2207/30196; H04W 4/024; G06F 3/012; G01C 21/20

(57) ABSTRACT

An electronic machine equipment includes an image acquisition device, a processing device and a control device. Said image acquisition device is configured to acquire action information of the user and generate acquired images. Said processing device is configured to obtain a first action said user want to perform based on said acquired images, determine a second action for said electronic machine equipment based on said first action, and generate and send control instructions to said control device based on said second action; and said control device controls said electronic machine equipment to execute said second action based on said control instructions. The electronic machine equipment can determine actions to be performed by itself according to the user's actions without planning routes in advance to accomplish a plurality of service tasks.

### TECHNICAL FIELD

Embodiments of the present disclosure relate to an electronic machine equipment.

### BACKGROUND

In recent years, robots with various functions such as sweeping robots and guiding robots have emerged in people's daily life. Among them, the guiding robot identifies objects based on large volume of image data, determines the user's intended destination, and guides the user to the intended place.

However, a guiding robot in prior art can only walk in a fixed region and guide the user to specified location, and needs to plan tracks in advance based on the present location and the destination and guides according to the planed route. While when a user wants to go to a place the robot never have been, the guiding robot will fail to fulfill the task.

### SUMMARY

The object of embodiments of the present disclosure is to provide an electronic machine equipment to address the above-mentioned technical problem.

According to at least one embodiment of this disclosure, an electronic machine equipment is provided, comprising an image acquisition device, a processing device and a control device, wherein the image acquisition device is configured to acquire an user's action information and generate acquired images; the processing device is configured to obtain a first action which is the user want to perform based on the acquired images, determine a second action for the electronic machine equipment based on the first action, and generate and send control instructions to the control device based on the second action; and the control device controls the electronic machine equipment to execute the second action based on the control instructions.

For example, the processing device determines whether the user has changed from an initial action to the first action based on the acquired images, wherein the initial action and the first action are actions of different types.

For example, the image acquisition device acquires action information of the user and generates at least contiguous first and second acquired images; the processing device compares the first acquired image and the second acquired image for an image information variation amount and determines whether the user has changed from the initial action to the first action based on the image information variation amount.

For example, the processing device subjects the first acquired image and the second acquired image to information extraction respectively and determines whether the user has changed from the initial action to the first action based on the image information variation amount between extracted information.

For example, the processing device subjects the first acquired image and the second acquired image to binarization respectively and determines whether the user has changed from the initial action to the first action based on the image information variation amount between binarized first acquired image and the second acquired image.

For example, the image acquisition device acquires action information of the user and generates at least contiguous first and second acquired images; the processing device analyses position variation information of the user in the first acquired image and the second acquired image and determines whether the user has changed from the initial action to the first action based on the position variation information.

For example, the processing device analyses coordinate position variation information of the user in the first acquired image and the second acquired image and determines whether the user has changed from the initial action to the first action based on the coordinate position variation information.

For example, further comprising a wireless signal transmitting device, wherein the wireless signal transmitting device is configured to transmit wireless signals to the user and receive wireless signals returned from the user; the processing device determines an image information variation amount between the transmitted wireless signals and the returned wireless signals and determines whether the user has changed from the initial action to the first action based on the image information variation amount.

For example, the first action is a displacement action, and the processing device determines an action direction and speed of the first action based on the first action; determines an action direction and speed for the electronic machine equipment based on the action direction and the action speed of the first action such that the action direction and action speed of the second action match the action direction and action speed of the first action.

For example, the processing device further acquires a position of the user and determines the movement direction and movement speed of the second action based on the user's position such that the electronic machine equipment keeps executing the second action in front of or beside the user by a predetermined distance.

For example, further comprising a first sensor, wherein the first sensor is configured to identify a luminance of ambient light and inform the processing device when the luminance of ambient light is greater than a first luminance threshold; the processing device stops execution of the second action based on the luminance notification.

For example, further comprising a second sensor, wherein the second sensor is configured to identify obstacles in predetermined range around the electronic machine equipment and send an obstacle notification to the processing device when the obstacles are identified; the processing device changes a direction and/or speed of the second action based on the obstacle notification.

For example, further comprising a third sensor and an alerting device, wherein the third sensor detects radio signals in a predetermined range and notifies the alerting device after detecting the radio signals; the alerting device reminds the user with information based on the radio signal notification.

For example, further comprising a fourth sensor, wherein the second action is a displacement action, the fourth sensor detects a position of the user in a predetermined range and sends position information to the processing device when detecting the position of the user; and the processing device determines a path from the electronic machine equipment to the position based on the position information and determines the displacement action in a direction towards the user based on the path.

For example, the fourth sensor detects information on a plurality of positions of the user in a predetermined period and sends the information on the plurality of positions to the processing device; the processing device determines whether there is any position variation of the user based on the information on the plurality of positions; and determines a path from the electronic machine equipment to the position based on the position information when it is determined there is no position variation and determines the displacement action in a direction towards the user based on the path.

For example, further comprising a storage unit, wherein the first action is a plurality of successive actions, the processing device determines a plurality of successive second actions for the electronic machine equipment based on the plurality of successive first actions and generates a movement path based on the plurality of successive second actions; and the storage unit is configured to store the movement path.

For example, further comprising a function key, wherein the storage unit stores at least one movement path, the function key is configured to determine a movement path corresponding to an input of the user based on the input, the processing device determines a second action for the electronic machine equipment based on the movement path and the first action.

For example, further comprising a second sensor, wherein the second sensor is configured to identify obstacles in predetermined range around the electronic machine equipment and send an obstacle notification to the processing device in response to identifying the obstacles; the processing device determines a second action for the electronic machine equipment based on the obstacle notification to enable the electronic machine equipment to avoid the obstacle.

For example, the processing device modifies the movement path based on the second action and sends the modified movement path to the storage unit; the storage unit stores the modified movement path.

For example, in response to failure to identify the obstacle, the second sensor sends an no-obstacle notification to the processing device; the processing device determines a second action for the electronic machine equipment based on the no-obstacle notification, based on the movement path and the first action.

With embodiments of the present disclosure, the electronic machine equipment can determine actions to be performed by itself according to the user's actions without planning routes in advance to accomplish a plurality of service tasks.

### BRIEF DESCRIPTION OF THE DRAWINGS

In order to explain the technical solution in embodiments of the present disclosure more clearly, accompanying drawings to be used in description of embodiments will be described briefly below. The accompanying drawings in the following description are merely illustrative embodiments of the present disclosure.

FIG. 1 shows a structure diagram of an electronic machine equipment according to an embodiment of the present disclosure;

FIG. 2 shows a profile design diagram of an electronic machine equipment according to an embodiment of the present disclosure;

FIG. 3 shows another structure diagram of an electronic machine equipment according to an embodiment of the present disclosure;

FIG. 4 shows a third structure diagram of an electronic machine equipment according to an embodiment of the present disclosure;

FIG. 5 shows a fourth structure diagram of an electronic machine equipment according to an embodiment of the present disclosure; and

FIG. 6 shows a flow chart of an obstacle handling procedure according to an embodiment of the present disclosure.

### DETAILED DESCRIPTION

Hereinafter, preferred embodiments of the present disclosure will be described in detail with reference to accompanying drawings. It is to be noted that in the present description and the drawings, basically identical steps and elements will be denoted by same reference numerals and redundant explanation thereof will be omitted.

In the following embodiments of the present disclosure, an electronic machine equipment refers to a machine equipment that may move on its own in a state without external instructions using digital and logical computing devices as an operation basis, such as an artificial intelligent equipment, a robot or a robot pet.

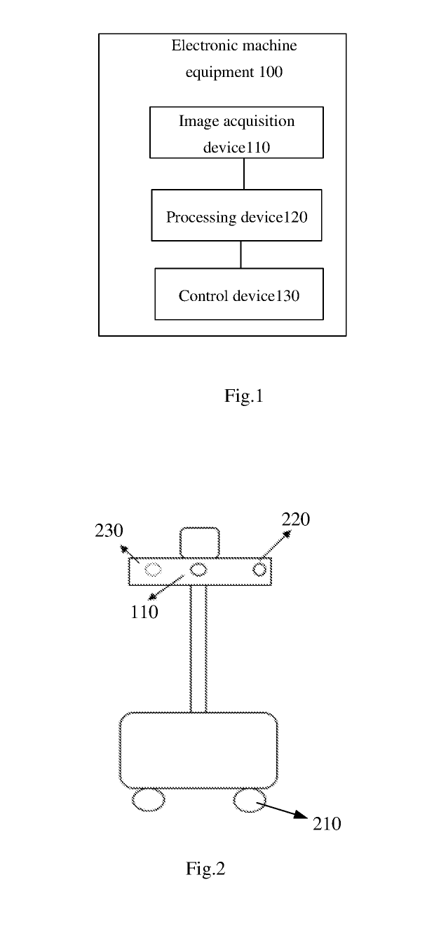

FIG. 1 shows a structure diagram of an electronic machine equipment according to an embodiment of the present disclosure. FIG. 2 shows a profile design diagram of an electronic machine equipment according to an embodiment of the present disclosure. Referring to FIG. 1, the electronic machine equipment 100 includes an image acquisition device 110, a processing device 120 and a control device 130.

The electronic machine equipment may include a driving device that may include a power component such as a motor and moving components such as wheels and caterpillar tracks and may execute actions such as start-up, stop, traveling straight, turning and climbing over obstacles according to instructions. Embodiments of the present disclosure are not limited to the specific types of the driving device.

The image acquisition device 110 is configured to acquire action information of the user and generate acquired images. The image acquisition device 110 may include, for example, one or more cameras etc. The image acquisition device 110 may acquire images in a fixed direction, and may also flip to capture image information at different locations and different angles. For example, the image acquisition device 110 may be configured to not only acquire visible light images but also acquire infrared light images, hence suitable for night environment. As another example, the images acquired by the image acquisition device 110 may be instantly stored in a storage device or stored in a storage device according to the user's instruction.

The processing device 120 is configured to obtain the first action the user want to perform based on images acquired by the image acquisition device 110, then determine the second action for the electronic machine equipment based on the first action, and generate and send control instructions to the control device based on the second action. The processing device 120 may be for example a general-purpose processor such as a central processor (CPU), or a special purpose processor such as a programmable logic circuit (PLC), a field programmable gate array (FPGA) etc.

The control device 130 controls the electronic machine equipment to execute the second action based on the control instructions. The control device 130, for example, may control actions of the electronic machine equipment such as walking, launching internal specific functions or emitting sounds. Control instructions may be stored in a predetermined storage device and read into the control device 130 while the electronic machine equipment is operating.

Referring to FIG. 2, examples in which the electronic machine equipment 100 is located may include a wheel 210, a function key 220 and a light source 230. The electronic machine equipment 100 may acquire images by the image acquisition device 110. The electronic machine equipment 100 may allow the user to input instructions by various function keys 220. The light source 230 may be turned on as desired for illumination and may be a LED light with tunable luminance. Of course, functional components in FIG. 2 are not necessary for embodiments of the present disclosure and one skilled in the art may appreciate that functional components may be added or reduced according to practical demands. For example, the function key 220 may be replaced with a touch screen etc.

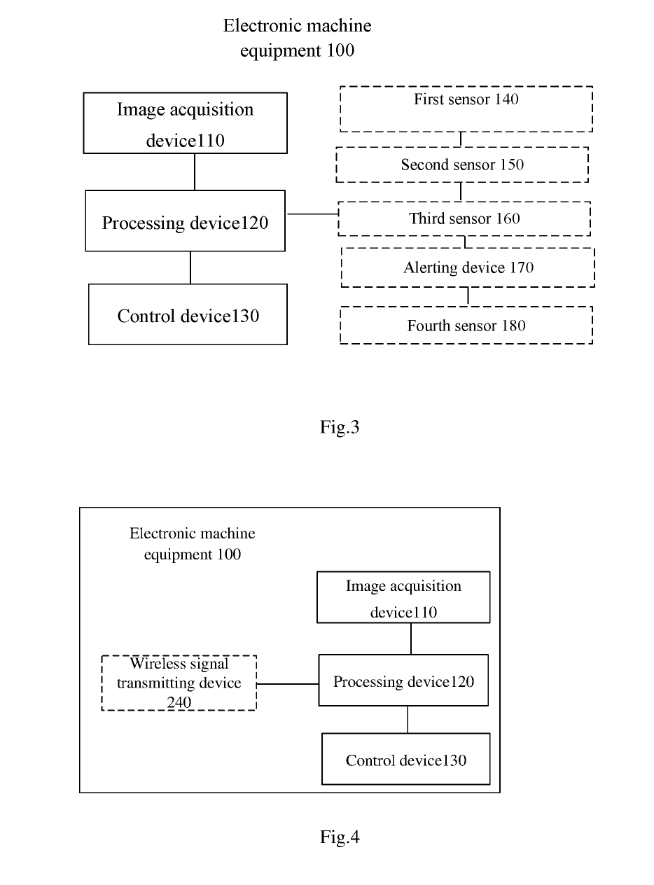

FIG. 3 shows another structure diagram of an electronic machine equipment according to an embodiment of the present disclosure. The structure and operation of the electronic machine equipment that may move on its own according to an embodiment of the present disclosure will be described below with respect to FIG. 3.

According to the embodiment of the present disclosure, the processing device 120 determines the first action of the user and determines the second action for the electronic machine equipment based on the first action. The first action may be for example a displacement action, a gesture action etc. The processing device 120 determines the action direction and action speed for the displacement action and determines the action direction and action speed for the electronic machine equipment based on the action direction and action speed of the first action such that the action direction and action speed of the second action for the electronic machine equipment match that of the first action for the user. Therefore, for example, the electronic machine equipment may provide guidance and illumination for the user when he or she is walking. Of course, the processing device 120 may also determines the action direction and action speed for the user's other gesture actions and determines the action direction and action speed for the electronic machine equipment based on the action direction and action speed of the first action such that the action direction and action speed of the second action for the electronic machine equipment match that of the first action for the user. For example, when the user is performing an operation, the electronic machine equipment may assist him or her to pass medical appliances according to the user's gestures. Embodiments of the present disclosure will be described below with respect to the user's displacement action as an example.

For example, after the processing device 120 determines the walking action of the user, in order to guarantee the user's safety in case that the user is a child or an elder, it may lead the user or function as an accompany for the user. While guiding, the electronic machine equipment may walk in front of or beside the user. If now no route is stored in advance inside the electronic machine equipment, then the desired destination of the user is unknown, it is possible to use the image acquisition device 110 to continuously acquire images containing the user and determine the user's movement direction by analyzing images and comparing a plurality of images. The electronic machine equipment may also determine the user's movement speed by the variation amount among a plurality of images and using parameters such as time. After determining the movement direction and movement speed of the user, the electronic machine equipment may determine the movement direction and speed of itself such that a relatively near distance is kept between them, thereby avoiding failure of accompanying due to a too far distance or collision with the user due to a too short distance. Furthermore, while guiding the user, the electronic machine equipment may further turn on a light source such as a night light for illumination such that the user can see roads clearly while walking at night, thereby improving the safety.

According to an example of the present disclosure, the processing device 120 may further acquire the user's location by, for example, analyzing the user's coordinates in the acquired images or based on indoor positioning technologies such as Wi-Fi, Bluetooth®, ZIGBEE and RFID. It is possible to determine the movement direction and speed of the second action of itself more accurately based on the user's location such that the electronic machine equipment keeps moving in front of or beside the user by a predetermined distance.

Referring to FIG. 3, the electronic machine equipment 100 may further include a first sensor 140 that may be for example an ambient light sensor capable of identifying luminance of ambient light. When the luminance of ambient light is greater than a first luminance threshold, the processing device 120 is informed and stops execution of the second action based on the luminance notification. For example, after the user turns on an indoor lamp, the user may not need any electronic machine equipment for assisting guidance and illumination. Therefore, the electronic machine equipment may stop moving or return to a preset default location after identifying lighting up indoor.

Referring to FIG. 3, the electronic machine equipment 100 may further include a second sensor 150 that may be for example a radar sensor, an infrared sensor, a distance sensor etc. capable of sensing obstacles in predetermined range around the electronic machine equipment. For example, after the processing device 120 receives an obstacle detection signal returned by the second sensor 150, it may for example analyze the signal to determine whether there is any obstacle on the route. The processing device 120 changes the direction and/or speed of the second action based on the presence or not of obstacles. As another example, the second sensor itself may also have processing capability to determine whether there is any obstacle and feed the information on presence or not of the obstacle back to the processing device 120. For example, a radar sensor determines whether there is any obstacle around by emitting radar signals around and based on variation of frequency or amplitude of the returned signals. An infrared sensor determines the distance from a front object and itself according to returned signals by emitting infrared signals around and the processor 120 may thereby determine whether the user's walking is influenced and whether it is required to change walking direction. While it is determined there is an obstacle, the processing device 120 may change the direction of the second action executed by itself and may also issue an alarm to the user to remind the user for attention.

Furthermore, referring to FIG. 3, the electronic machine equipment may further include a third sensor 160 and an alerting device 170, in which the third sensor 160 may be for example a radio signal sensor capable of detecting radio signals in predetermined range and informing the alerting device 170 while detecting the presence of radio signals. The alerting device 170 may be for example a speaker, a LED light etc. that may draw the user's attention to remind the user. For example, when a user is not carrying his or her mobile phone with him or her, when the radio signal sensor of the electronic machine equipment senses an incoming phone call or an incoming short message, the user may be informed of the call information or the short message information, thereby avoiding missing important calls due to the small volume or mute state of the phone. Of course, the electronic machine equipment may further play the incoming call information or the short message information.

In addition, referring to FIG. 3, the electronic machine equipment may further include a fourth sensor 180 that may be for example an infrared sensor capable of detecting the location of the user in a predetermined range. When detecting the location of the user, the fourth sensor 180 may, for example, send the user location information to the processing device 120. The processing device 120 determines the route from the electronic machine equipment to the user's location based on the location information and determines the displacement action of walking towards the user's direction based on the route. For example, the electronic machine equipment may determine the user's location and then help the user to send him/or the desired object according to the user's instructions. The infrared sensor may for example determine the user's location by detecting temperature and distance, and may also determine the user's location by temperature in combination with the physical profile to avoid misjudgment.

Furthermore, According to an example of the present disclosure, the fourth sensor 180 may detect a plurality of location information of the user in a predetermined period and send the plurality of location information to the processing device 120. The processing device 120 determines whether there is any location variation for the user based on the plurality of location information. While it is determined that there is no location variation, the processing device 120 determines the route from the electronic machine equipment to the location based on the location information and determines the displacement action towards the user's direction based on the route. For example, within 10 seconds, if a plurality of captured images all indicate that the user is at a fixed location, it means that the user does not experience any location variation. Now, the processing device 120 may determine the distance between the user and the electronic machine equipment to determine the user's location for sending his/her desired object. If it is determined that the user is moving continuously by analyzing the captured plurality of images, which means the user's location is now changing, then the electronic machine equipment needs not to send the user objects, thereby avoiding wasting of processing resources due to continuously positioning the user.

With the embodiments of the present disclosure, the second action for the electronic machine equipment is determined by determining the user's first action such that the second action is consistent with the first action, thereby allowing the electronic machine equipment to guide the user even if there is no preset route and ensuring that the electronic machine equipment may execute respective task according to the user's demand at any time.

FIG. 4 shows a third structure diagram of an electronic machine equipment according to an embodiment of the present disclosure. The structure and operation of the electronic machine equipment that may move on its own according to an embodiment of the present disclosure will be described below with respect to FIG. 4.

In the embodiment of the present disclosure, the processing device 130 may determine whether the user change from the initial action to the first action based on the acquired images in which the initial action and the first action are actions of different types. That is, the processing device 130 may determine whether the user is experiencing action variation. In embodiments of the present disclosure, actions of different types or action variation refers to two actions one after another that are actions with different attributes. For example, eating action and walking action, getting up action and sleeping action, learning action and playing action etc. are all belong to actions of different types. In contrast, if the user changes from left arm reclining to laying low or right arm reclining while sleeping, they still belong to the sleeping action thought actions change and therefore do not belong to the actions of different types defined in the present disclosure.

For example, the image acquisition device 110 acquires action information of the user and generates the first and second acquired images or more acquired images. The processing device 120 compares the first acquired image and the second acquired image or a plurality of acquired images for the image information variation amount and determines whether the user has changed from the initial action to the first action based on the image information variation amount. For example, the first and second acquired images may be successive two frames of images and the processing device 120 may effectively identify whether the user has changed action by comparing the former and the latter frames.

For the determination and comparison of image information variation amount, the processing device 120 may perform comparison based directly on two or more images themselves, or alternatively may extract information from the first and second acquired images respectively for important information in images and determine whether the user has changed from the initial action to the first action based on the image information variation amount between the extracted information. For example, the first and second acquired images are subjected to binarization respectively and determine whether the user has changed from the initial action to the first action based on the image information variation amount between the binarized first and second acquired images. Alternatively, background information in the images is removed and it is determined whether the user's action has change by comparing the foreground information. Alternatively, all images are subjected to profile extraction and variation between two images is determined by comparing the profile information. In such way, it is possible to effectively decrease the calculation amount and improve the processing efficiency.

It is possible to determine the image information variation amount according to the overall content of the processed image. For example, after the binarization of the first and second acquired images, pixel values in each image are accumulated and the difference value between accumulated pixel values of each image is compared to determine whether it is greater than a preset threshold. The threshold may be set to a value from 20-40% according to practical demand. When the accumulated value is greater than the preset threshold, it may be considered that the user has changed from the initial action to the first action. When the accumulated value is less than the preset threshold, it may be considered that the user still keeps the initial action. For example, if the user only turns over while sleeping, the difference value between accumulated values of the latter and the former frames is 15%, then it may be considered that the user still keeps sleeping action.

Additionally, according to other embodiments of the present disclosure, it is also possible to determine whether the user has changed from the initial action to the first action by determining the user's position variation in the former and latter images. For example, the image acquisition device 110 contiguously acquires action information of the user and generates at least the contiguous first and second acquired images. The processing device 120 analyses the position variation information of the user in the first acquired image and the second acquired image and determines whether the user has changed from the initial action to the first action based on the position variation information. For example, the processing device 120 sets a unified coordinate system for each image acquired by the image acquisition device 110. For example, after the user enters the sleeping action, the abscissa is set with the head of the bed on the bed surface as the origin and the direction from the head to end on the surface as the X-axis direction, and the ordinate is set with the direction toward the ceiling perpendicular to the bed surface at the head position as the Y-axis direction. Thereby, when the user's action changes, it is possible to determine whether he or she changes from one type of action to another type of action according to the variation of the user's coordinates. For example, in order to reduce the calculation amount, it is possible to detect only the variation value in the Y-axis direction to determine whether the user has changed from the initial action to the first action. For example, it is possible to set a coordinate variation threshold in advance, which may be set to for example, a value between 5%-20% according to historical data. When the ordinate of the user's head changes from 10 cm to 50 cm, with a variation value greater than the threshold, it may be considered that the user has changed from sleeping action to getting up action. When the ordinate of the user's head changes from 10 cm to 12 cm, with a variation value less than the threshold, it may be determined that the user is still in the sleeping state.

Furthermore, the electronic machine equipment may further determine whether the user has changed from the initial action to the first action by the wireless signal transmitting device. As shown in FIG. 2, the electronic machine equipment 100 may be further provided with a wireless signal transmitting device 240 that may be, for example, a radar transmission transducer, an ultrasonic wave transmitter and an infrared signal transmitter etc. The wireless signal transmitting device 240 may transmit various wireless signals to the user and receive wireless signals returned from the user. Of course, the wireless signal transmitting device 240 may also transmit signals to possible action regions around the user rather than transmitting signals to the user in order to determine whether the user is executing respective actions. The processing device 120 may determine the image information variation amount between the wireless signals transmitted by the wireless signal transmitting device 240 and the wireless signals returned by the user. Since the intensity of returned information varies depending on whether the transmitted wireless signals are blocked and blocked by what kind of objects, it is possible to determine whether the user has changed from the initial action to the first action based on the signal variation amount. The above-mentioned image information variation amount may be the signal frequency variation amount or signal amplitude variation amount, or the combination of both. For example, when the frequency variation amount is 200-500 Hz, which indicates the frequency variation amount is small and the action is not changed; and when the frequency variation amount is 1000-3000 Hz, which indicates the frequency variation amount is large, it may be considered that the user's action is changed from the initial action to the first action.

With the embodiments of the present disclosure, it is possible to efficiently prejudge what the user want to do or where it user want to go and provide the user with services more timely and more accurately by determining and analyzing acquired images containing user actions to determine whether the user has changed from one action to another action and determining the next action for the electronic machine equipment according to the change.

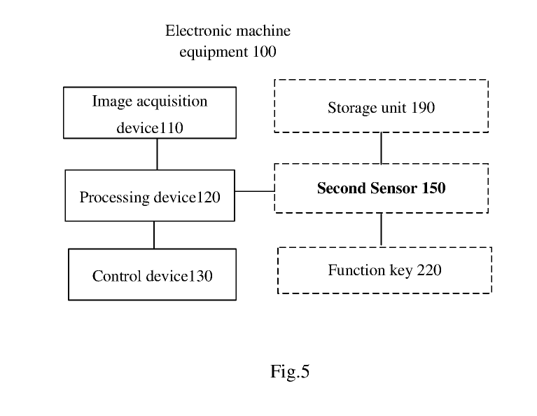

FIG. 5 shows a fourth structure diagram of an electronic machine equipment according to an embodiment of the present disclosure. Referring to FIG. 5, the electronic machine equipment 100 may include a storage unit 190 in addition to the image acquisition device 110, the processing device 120 and the control device 130.

In embodiments of the present disclosure, it is possible to train the electronic machine equipment to learn such that it remembers at least one stored route. The image acquisition device 110 may acquire a plurality of first actions that may be a plurality of successive actions such as a plurality of displacement actions. The processing device 120 determines a plurality of successive second actions for the electronic machine equipment and generates the movement path based on the plurality of successive second actions. That is, the processing device 120 may remember the guidance path after guiding the user and send the path to the storage unit 190 that stores the movement path.

Furthermore, the electronic machine equipment 100 may be further provided with a plurality of function keys 220 that may receive the user's input and determine the movement path stored in the storage unit 190 corresponding to the user input. The processing device 120 may determine the second action for the electronic machine equipment based on the user's selection input and according to the movement path and the user's first action. For example, by default, the processing device 120 may guide the user to move along a stored movement path, however at the same time the processing device 120 also needs to consider the first action of the user. If the user suddenly changes the direction during walking, the electronic machine equipment 110 may change the second action of itself as desired to meet the user's demand.

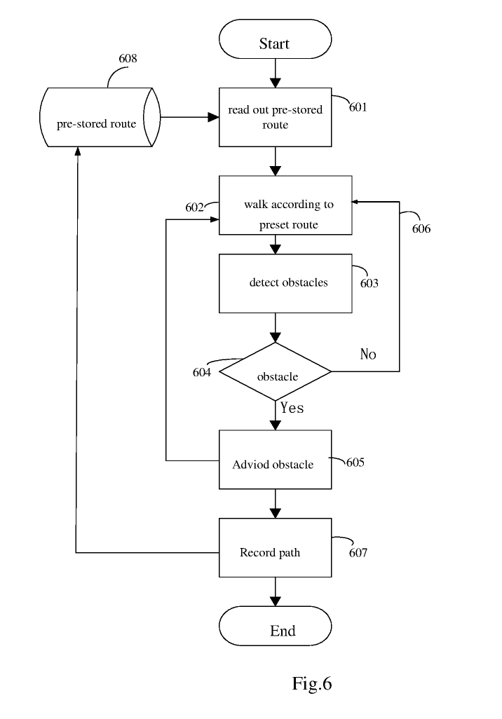

According to an example of the present disclosure, the electronic machine equipment further has a function of identifying obstacles. FIG. 6 shows a flow chart of an example of an obstacle handling method according to an embodiment of the present disclosure. The electronic machine equipment may further include a second sensor 150 that may be for example a sensor transmitting radar signals, which may determine whether there is any obstacle in predetermined range around the electronic machine equipment according to the returned wireless signals by transmitting wireless signals around.

In step 601, the processing device 120 may read out prestored routes in the storage unit 190.

In step 602, the processing device 120 may control to walk according to the set route.

In step 603, it is possible to use the second sensor 150 to identify obstacles.

In step 604, it is determined whether there is any obstacle.

In step 605, when it is determined there is an obstacle in the route, an obstacle notification is sent to the processing device 120 that determines the second action for the electronic machine equipment based on the obstacle notification to enable the electronic machine equipment to avoid the obstacle.

In step 606, if no obstacle is identified, the second sensor 150 may also send a no-obstacle notification to the processing device 120 that determines the second sensor of itself still according to the prestored movement path in the storage unit 190 and the user's first action and instructs the second sensor 150 to continue detecting obstacles at the same time.

In step 607, after avoiding the obstacle, the processing device 120 may record the movement path of avoiding the obstacle.

In step 608, the processing device 120 may further send the newly stored movement path to the storage unit 190 that stores the new movement path for future selection and use by the user.

Alternatively, after the electronic machine equipment avoids the obstacle, the processing device 120 may instruct to continue walking according to the set route read out before.

Alternatively, it is possible to use a newly recorded path to update the path stored previously and then the processing device 120 may determine the second action for the electronic machine equipment according to the updated movement path or according to the user's further selection.

With the embodiments of the present disclosure, it is also possible to move according to the path selected by the user and according to the user's input selection while effectively avoiding obstacles by training the electronic machine equipment to store one or more stored paths. It makes the electronic machine equipment more powerful and satisfies user's different requirements.

The skilled in the art may realize that, the units and arithmetic process in each example described with the embodiments disclosed in this disclosure can be achieved through electronic hardware, computer software or the combination of the both. Also, the software module may be set in any kinds of computer mediums. In order to describe clearly the interchangeability of hardware and software, the constitution and steps of each example have been described generally in terms of function in the description above. These functions is implemented with hardware or software is due to the specific application and design restriction condition of the technical solution. The skilled in the art may use different method to achieve the described function pointing to each specific application, however, the achievement should not be considered over the scope of this disclosure.

One skilled in the art should understand the present disclosure may be subjected to various modifications, combinations, parts combination and substitution depending on design requirements and other factors as long as they are within the scope of the appended claims and their equivalents.

The present application claims priority of China Patent Application No. 201610652816.1 filed on Aug. 10, 2016, the content of which is hereby incorporated herein in its entirety by reference as a part of the present application.

1. An electronic machine equipment comprising an image acquisition device, a processing device and a control device,
wherein the image acquisition device is configured to acquire an user's action information and generate acquired images;
the processing device is configured to obtain a first action which is the user want to perform based on the acquired images, determine a second action for the electronic machine equipment based on the first action, and generate and send control instructions to the control device based on the second action; and
the control device controls the electronic machine equipment to execute the second action based on the control instructions.

2. The electronic machine equipment of claim 1, wherein the processing device determines whether the user has changed from an initial action to the first action based on the acquired images, wherein the initial action and the first action are actions of different types.

3. The electronic machine equipment of claim 2, wherein the image acquisition device acquires action information of the user and generates at least contiguous first and second acquired images;
the processing device compares the first acquired image and the second acquired image for an image information variation amount and determines whether the user has changed from the initial action to the first action based on the image information variation amount.

4. The electronic machine equipment of claim 3, wherein the processing device subjects the first acquired image and the second acquired image to information extraction respectively and determines whether the user has changed from the initial action to the first action based on the image information variation amount between extracted information.

5. The electronic machine equipment of claim 4, wherein the processing device subjects the first acquired image and the second acquired image to binarization respectively and determines whether the user has changed from the initial action to the first action based on the image information variation amount between binarized first acquired image and the second acquired image.

6. The electronic machine equipment of claim 2, wherein the image acquisition device acquires action information of the user and generates at least contiguous first and second acquired images;
the processing device analyses position variation information of the user in the first acquired image and the second acquired image and determines whether the user has changed from the initial action to the first action based on the position variation information.

7. The electronic machine equipment of claim 6, wherein
the processing device analyses coordinate position variation information of the user in the first acquired image and the second acquired image and determines whether the user has changed from the initial action to the first action based on the coordinate position variation information.

8. The electronic machine equipment of claim 2, further comprising a wireless signal transmitting device,
wherein the wireless signal transmitting device is configured to transmit wireless signals to the user and receive wireless signals returned from the user;
the processing device determines an image information variation amount between the transmitted wireless signals and the returned wireless signals and determines whether the user has changed from the initial action to the first action based on the image information variation amount.

9. The electronic machine equipment of claim 1, wherein
the first action is a displacement action, and the processing device determines an action direction and speed of the first action based on the first action;
determines an action direction and speed for the electronic machine equipment based on the action direction and the action speed of the first action such that the action direction and action speed of the second action match the action direction and action speed of the first action.

10. The electronic machine equipment of claim 9, wherein
the processing device further acquires a position of the user and determines the movement direction and movement speed of the second action based on the user's position such that the electronic machine equipment keeps executing the second action in front of or beside the user by a predetermined distance.

11. The electronic machine equipment of claim 1, further comprising a first sensor,
wherein the first sensor is configured to identify a luminance of ambient light and inform the processing device when the luminance of ambient light is greater than a first luminance threshold;
the processing device stops execution of the second action based on the luminance notification.

12. The electronic machine equipment of claim 1, further comprising a second sensor,
wherein the second sensor is configured to identify obstacles in predetermined range around the electronic machine equipment and send an obstacle notification to the processing device when the obstacles are identified;
the processing device changes a direction and/or speed of the second action based on the obstacle notification.

13. The electronic machine equipment of claim 1, further comprising a third sensor and an alerting device,
wherein the third sensor detects radio signals in a predetermined range and notifies the alerting device after detecting the radio signals;
the alerting device reminds the user with information based on the radio signal notification.

14. The electronic machine equipment of claim 1, further comprising a fourth sensor,
wherein the second action is a displacement action,
the fourth sensor detects a position of the user in a predetermined range and sends position information to the processing device when detecting the position of the user; and
the processing device determines a path from the electronic machine equipment to the position based on the position information and determines the displacement action in a direction towards the user based on the path.

15. The electronic machine equipment of claim 14, wherein
the fourth sensor detects information on a plurality of positions of the user in a predetermined period and sends the information on the plurality of positions to the processing device;
the processing device determines whether there is any position variation of the user based on the information on the plurality of positions; and determines a path from the electronic machine equipment to the position based on the position information when it is determined there is no position variation and determines the displacement action in a direction towards the user based on the path.

16. The electronic machine equipment of claim 1, further comprising a storage unit,
wherein the first action is a plurality of successive actions, the processing device determines a plurality of successive second actions for the electronic machine equipment based on the plurality of successive first actions and generates a movement path based on the plurality of successive second actions; and
the storage unit is configured to store the movement path.

17. The electronic machine equipment of claim 1, further comprising a function key,
wherein the storage unit stores at least one movement path,
the function key is configured to determine a movement path corresponding to an input of the user based on the input,
the processing device determines a second action for the electronic machine equipment based on the movement path and the first action.

18. The electronic machine equipment of claim 17, further comprising a second sensor,
wherein the second sensor is configured to identify obstacles in predetermined range around the electronic machine equipment and send an obstacle notification to the processing device in response to identifying the obstacles;
the processing device determines a second action for the electronic machine equipment based on the obstacle notification to enable the electronic machine equipment to avoid the obstacle.

19. The electronic machine equipment of claim 18, wherein
the processing device modifies the movement path based on the second action and sends the modified movement path to the storage unit;
the storage unit stores the modified movement path.

20. The electronic machine equipment of claim 18, wherein
in response to failure to identify the obstacle, the second sensor sends an no-obstacle notification to the processing device;
the processing device determines a second action for the electronic machine equipment based on the no-obstacle notification, based on the movement path and the first action.
